(19) United States
(12) Patent Application Publication
(10) Pub. No.: US 2005/0122973 A1
(43) Pub. Date: Jun. 9, 2005

(54) Network node capable of restricting a packet receiving activity during packet congestion and method thereof

(75) Inventors: Jin-hyung Kim, Suwon-si (KR); Hyun-wook Park, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/986,805

(22) Filed: Nov. 15, 2004

(30) Foreign Application Priority Data
Dec. 9, 2003 (KR) 2003-89014
May 13, 2004 (KR) 2004-33982

(51) Int. Cl. H04L 12/56

(52) U.S. Cl. 370/389

(57) ABSTRACT

A network communication node for receiving packets through a network. The network communication node comprises a network communication module for receiving a predetermined number of packets from a predetermined corresponding node linked thereto through a network; a memory for storing first information about a predetermined criterion for reception restriction; and a controller for checking a packet receiving condition of the network communication module and determining whether the criterion for reception restriction is satisfied, and according to a result of the determination, controlling the restriction of the reception of the predetermined packets of the network communication module. Accordingly, the reception of packets is restricted in data congestion, and thus the data congestion can be immediately resolved.

### CROSS-REFERENCE TO RELATED APPLICATIONS

This application claims the benefit under 35 USC 119(a) of Korean Patent Application Nos. 2003-89014, filed on Dec. 9, 2003, and 2004-33982, May 13, 2004, in the Korean Intellectual Property Office, the entire contents of which are incorporated herein by reference.

### BACKGROUND OF THE INVENTION

1. Field of the Invention

The present invention relates to a network system, a network node constituting the network system, and a data communication method thereof. More particularly, the present invention relates to a network node and a network system which checks a communicating condition of the network system and restricts a data receiving activity during data congestion, and a communicating method thereof.

2. Description of the Related Art

With the development of computers and electronic communication technologies, personal computers in offices are typically networked to one another through one signal network. Recently, network technology has become popular and thus enables several computers in homes to be networked.

As for image forming apparatuses, such as printers, scanners, and multi-function peripherals, which are not used frequently as much as PCs, it is unnecessary to provide one for each individual in the office, and in general, image forming apparatuses are networked.

FIG. 1 is a view showing a general network system connected to the Internet 10. Referring to FIG. 1, the network system comprises a plurality of communication nodes 40a, 40b, . . . , 40n, 50 connected to the Internet 10 through a router 20. The router 20 refers to a hardware or software device that connects two networks for mutual communication therebetween. If the router 20 is connected with several nodes such as the plurality of nodes 40a, 40b, . . . , 40n, 50 of FIG. 1, it divides a circuit using a hub 30. The hub 30 receives and transmits data to and from at least one node connected thereto. The hub 30 may be connected with various nodes, for example, a plurality of PCs 40a to 40n, a network printer 50, and a scanner (not shown). The respective nodes, connected with the hub 30, exchange data packets with one another and external nodes connected through the Internet.

FIG. 2 is a flowchart showing exemplary steps of a conventional data communication method performed by a certain node of the network system of FIG. 1. Referring to FIG. 2, when a node is turned on, its inner parts are initialized at step S61. Because the node constitutes the network system, it performs operations for the network system in addition to a general set-up operation of the node during the initialization.

More specifically, the node designates a memory to store packets, and selects a Media Access Control (MAC) address (or a node address) of the packets to be received to determine which packets to receive among broadcast packets, multicast packets, and unicast packets.

Next, the node receives certain packets based on the selected MAC address at step S62. That is, the node establishes links to the hub 30 and other nodes according to a pre-set value, and receives the packets through the established links.

Next, it is determined whether the received packets are normal e.g., without errors at step S63. If the packets are determined to be normal, the node checks the address of the received packets at step S64) and then determines whether the packets have a receivable MAC address at step S65. If the packets have the receivable address, the packets are stored in the designated memory at step S66. If the received packets are abnormal or they do not have the receivable address, the packets are discarded without being stored in the memory at step of S67.

The normally received and stored packets are transmitted to an upper protocol layer or other application programs, and processed according to the contents of the packets at step S68. Then, the memory is released from the designation at step S68. The above-described steps are repeated until the node is turned-off or disconnected from the network at step S69.

In the process of receiving packets, if a large amount of data is unexpectedly received from the network at the same time, the corresponding node lacks the memory to receive the data and thus cannot receive the subsequent packets. In the case of broadcast packets, which are transmitted without a specific address designated, if higher priority data packets are subsequently received during data congestion, the high priority data packets are susceptible to being discarded. Therefore, the data packets are not processed. This problem becomes worse in a system, such as a network printer which supports the network function and a Personal Digital Assistant (PDA), having a relatively slow data processing rate and a limited memory.

Also, there is a problem in that the delay in processing preceding relatively trivial data causes a delay in processing subsequent relatively more important data.

Also, if network traffic to be processed increases in the middle of the node performing a specific operation, it affects the specific operation. This problem occurs more frequently in the network printer 50 that performs a printing job by using mechanical elements.

FIG. 3 is a block diagram showing a general network printer 50 of the network system of FIG. 1. Referring to FIG. 3, the network printer 50 comprises a CPU 51, a data communication module 52, a memory 53, an engine part 54, and a system bus 55. The CPU 51 transmits and receives data to and from the respective components through the system bus 55. The data communication module 52 receives print data from networked PCs and stores the print data in the memory 53. The CPU 51 performs a rendering operation by reading the print data from the memory 53 and converting the print data into a bitmap image. The bitmap image converted by the CPU 51 is transmitted to the engine part 54 through the system bus 55, and the engine part 54 prints the bitmap image onto paper.

Recently, the network printer 50 installs a network card in a main board of the printer so that overall operations are controlled through the single CPU 51. In this case, however if the network printer 50 receives packets more than expected, there occurs a calculation delay in the CPU 51 or a transmission delay in the system bus 55. If the packet congestion occurs when the CPU 51 performs the rendering with respect to the print data and transmits the data to the engine part 54, the bitmap image cannot be prepared in a proper time and thus an error occurs. That is, the engine part 54 malfunctions so that it suddenly stops the printing operation or prints only the part where the rendering is completed. Thus, there are problems of a delayed printing time and a waste of printing paper.

In order to solve these problems, it has been proposed that a printer system and a network card are embodied as an independent system. However, in this case, manufacturing costs of the network printer increase.

### SUMMARY OF THE INVENTION

The present invention has been developed in order to solve the above problems in the related art. Accordingly, an aspect of the present invention is to provide a network communication node which restrict a data packet receiving activity during data congestion, a network system having the network node, and a data communication method thereof.

Another aspect of the present invention is to provide a network printer which restricts a packet receiving activity when a data congestion is detected during a specific operation, and if the data congestion is not resolved even after the first restriction is performed, restricts a receiving activity of all data packets, thereby preventing a malfunction, and a method thereof.

The above aspects are achieved by providing a network communication node according to an embodiment of the present invention. The network communication node comprises a network communication module for receiving a predetermined number of packets from a predetermined corresponding node linked thereto through a network; a memory for storing information about a predetermined criterion for reception restriction; and a controller for checking a packet receiving condition of the network communication module and determining whether the criterion for reception restriction is satisfied, and according to a result of the determination, controlling the restriction of the reception of the predetermined packets of the network communication module.

The memory may include a first memory for storing the packets received through the network communication module, and a second memory for storing information about the criterion for reception restriction and information about packets to be restricted when the criterion for reception restriction is satisfied.

The network communication node may further comprise an input/output interface for receiving a designation command from an external input device for designating the packet for reception restriction. The network communication node may further comprise the controller changing the information about the packet for reception restriction stored in the second memory according to the designation command.

The network communication module may comprise a data transceiver for establishing a link to the corresponding node and receiving the packets through the link; and a MAC, if the packet receiving activity is controlled to be restricted, reading the information from the second memory, and storing in the first memory receivable packets among the packets received through the data transceiver.

In this case, the criterion for reception restriction may be determined by a reference capacity of the first memory. The controller determines that the criterion for reception restriction is satisfied if the received packets occupy in the first memory more than the reference capacity, and sets the reception restriction.

The criterion for reception restriction may be determined by an upper reference capacity and a lower reference capacity of the first memory. The controller sets the reception restriction if the received packets occupy more than the upper reference capacity in the first memory, and allows the reception if the packets stored in the first memory are processed and thus occupy less than the lower reference capacity in the first memory.

Also, the criterion for reception restriction may be determined by a predetermined packet receiving rate. The controller sets the reception restriction if the packet receiving rate exceeds a reference receiving rate.

The controller may determine whether to restrict the reception of at least one of a broadcast packet, a multicast packet and a unicast packet.

According to another embodiment, a network communication module comprises a data transceiver for receiving certain packets from a corresponding node connected thereto through a network; a memory for storing information about packets to be restricted; a controller for setting a reception restriction with respect to certain packets if it is determined that a predetermined operation is performed, and allowing a reception of the certain packets when the operation is completed; and a MAC, if the reception restriction is set, for reading the information about the packet to be restricted from the memory, and restricting the certain packets among packets received through the data transceiver.

According to still another embodiment, a network printer comprises a data transceiver for receiving packets from a corresponding node connected to the network printer through a network; an engine part for performing a printing according to a predetermined image data; a controller for setting a reception restriction with respect to certain packets when detecting a packet congestion at the data transceiver during the printing; and a MAC, if the reception restriction is set, controlling the data transceiver to restrict the reception of the certain packets.

In this case, the controller counts a number of packets received through the data transceiver per a time unit and compares the counted number with a predetermined threshold, and if the number of the received packets exceeds the threshold, confirms the packet congestion.

The network printer may further comprise a first memory for storing packets received from the corresponding node; and a second memory for storing information about packets for reception restriction when the packet congestion occurs, and information about the threshold.

The controller may periodically check a packet receiving condition, and set a reception restriction with respect to all of the packets when the packet congestion is determined to continue under the reception restriction condition.

Also, the controller may convert a print data written in a print language into an image data by performing a rendering in every page, transmit the image data to the engine part to perform the printing, and, if the rendering with respect to each page is completed, allow the reception of all of packets prior to performing a rendering of the next page.

The controller may cancel the reception restriction if the printing operation is completed.

In the printer network, the controller may set the reception restriction with respect to at least one of a broadcast packet, a multicast packet and unicast packets.

A data communication method of the network communication node according to an embodiment of the present invention comprises the steps of (a) the network communication node receiving a predetermined number of packets from the corresponding node; (b) checking a packet receiving condition and determining whether a criterion for reception restriction is satisfied; (c) if the criterion for reception restriction is satisfied, setting a reception restriction with respect to a pre-set packet; and (d) restricting reception of the packets which the reception restriction is set on.

The data communication method may further comprise the steps of: determining which packet to restrict when the criterion for reception restriction is satisfied; and if it is not determined which packet to restrict, determining which packet to restrict according to an initial setting condition of the network communication node.

The step of (c) may use a predetermined reference capacity of a memory provided in the network communication node as the criterion for reception restriction, and if a storage capacity the received packets occupy in the memory exceeds the reference capacity, determines that the criterion for reception restriction is satisfied.

The step of (c) may use a predetermined upper reference capacity and a lower reference capacity of a memory provided in the network communication node as the criterion for reception restriction. If a storage capacity the received packets occupy in the memory exceeds the upper reference capacity, the step of (c) determines that the criterion for reception restriction is satisfied, and if the packets are processed and thus a storage capacity the packets occupy in the memory is below the lower reference capacity, it determines that the criterion for reception restriction is not satisfied and allows the reception.

The step of (c) may use a predetermined receiving rate of the network communication node as the criterion for reception restriction. If it is determined that the receiving rate exceeds a predetermined reference receiving rate, the step of (c) determines that the criterion for reception restriction is satisfied.

In the data communication method, the reception restriction may be set with respect to at least one of a broadcast packet, a multicast packet, and a unicast packet.

According to another embodiment of the present invention, a data communication method of a network communication node comprises the steps of receiving predetermined packets from a corresponding node; determining whether the network communication node is now performing a predetermined operation; setting a reception restriction with respect to certain packets when the network communication is now performing the operation, restricting the certain packet from being received among packets received from the corresponding node if the reception restriction is set, and canceling the reception restriction if it is determined that the network communication node completes the operation.

According to still another embodiment, a data receiving method of a network printer comprises the steps of (a) receiving a predetermined print data from a corresponding node; (b) converting the print data to a predetermined image data and printing the image data on a paper; (c) checking a receiving condition of the packets received from the corresponding node during the printing; (d) setting a reception restriction with respect to certain packets when the receiving condition is determined to be a packet congestion; and (e) restricting the reception of the certain packet when the reception restriction is set.

The step of (d) may comprise the steps of counting a number of packets received from the corresponding node per a time unit; comparing the number of packets received per a time unit with a predetermined threshold; and if the number of packets exceeds the threshold, determining that the packet receiving condition is in a packet congestion.

The data receiving method may further comprise the step of determining packets to be restricted and setting the threshold when the packet congestion occurs.

The data receiving method may further comprises the steps of: periodically checking the packet receiving condition; and setting a reception restriction with respect to all of the packets if it is determined that the packet congestion continues under the reception restriction condition.

Also, the data receiving method further comprise the step of canceling the reception restriction with respect to all packets when the printing operation is completed.

The data receiving method may further comprises the steps of if a print data written in a print language is received from the corresponding node, performing a rendering of converting the print data to a predetermined image data in every page; and if the rendering is completed with respect to each page, allowing the reception of all of the packets prior to performing a rendering with respect to the next page.

In the data receiving method of the network printer, the step of (d) may set the reception restriction with respect to at least one of a broadcast packet, a multicast pact, and a unicast packet.

### BRIEF DESCRIPTION OF THE DRAWING FIGURES

The above aspects and other advantages of the present invention will be more apparent by describing embodiments of the present invention with reference to the accompanying drawings, in which:

FIG. 1 is a block diagram showing a conventional network system connected to the Internet;

FIG. 2 is a flowchart showing exemplary steps of a packet receiving method performed by a network communication node of a conventional network system;

FIG. 3 is a block diagram showing a conventional network printer;

FIG. 4 is a block diagram showing a network communication node of a network system according to an embodiment of the present invention;

FIG. 5 is a block diagram showing the network communication module used in the network communication node of FIG. 4;

FIG. 6 is a view showing a user interface window to control a packet receiving activity in a network communication node according to an embodiment of the present invention;

FIG. 7 is a flowchart showing exemplary steps of a packet receiving method of a network communication node according to an embodiment of the present invention;

FIG. 8 is a flowchart showing exemplary steps of the method of controlling the packet receiving activity of FIG. 7 according to a first embodiment of the present invention;

FIG. 9 is a flowchart showing exemplary steps of the method of controlling the packet receiving activity of FIG. 7 according to a second embodiment of the present invention;

FIG. 10 is a flowchart showing exemplary steps of the method controlling the packet receiving activity of FIG. 7 according to a third embodiment of the present invention;

FIG. 11 is a block diagram showing a network printer according to an embodiment of the present invention; and

FIG. 12 is a flowchart showing exemplary steps of a packet receiving method of the network printer of FIG. 11.

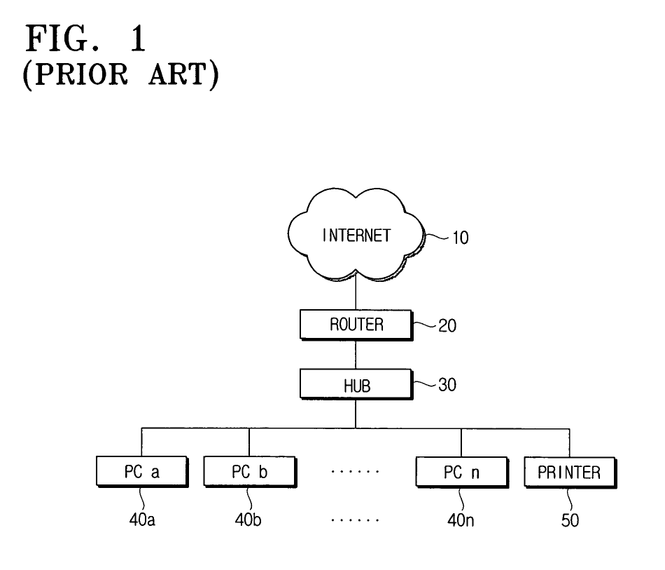

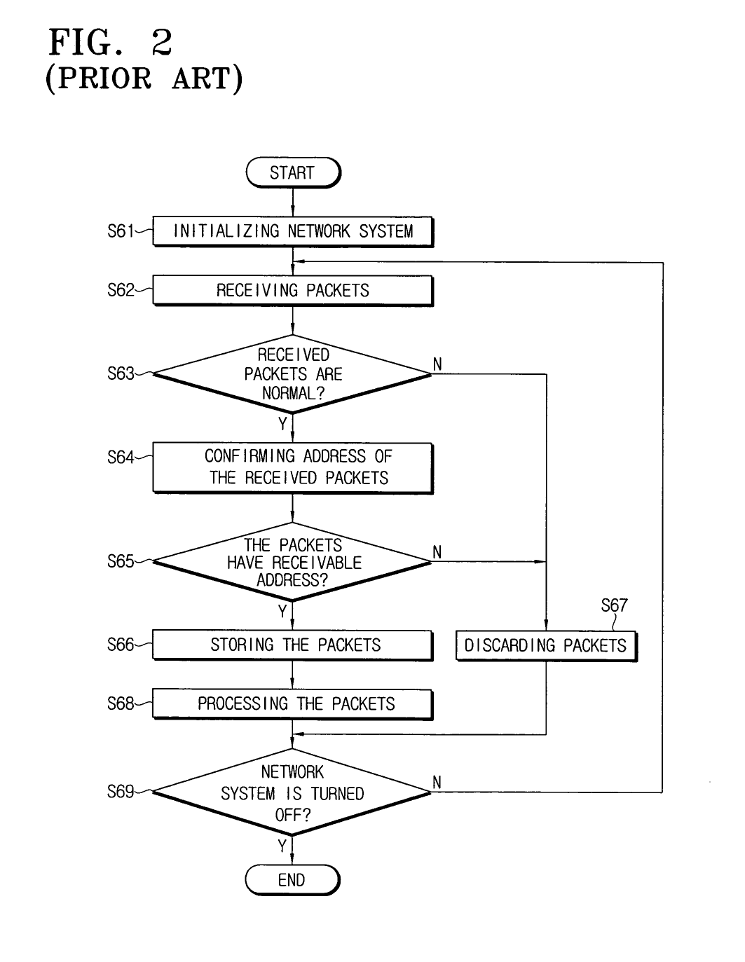

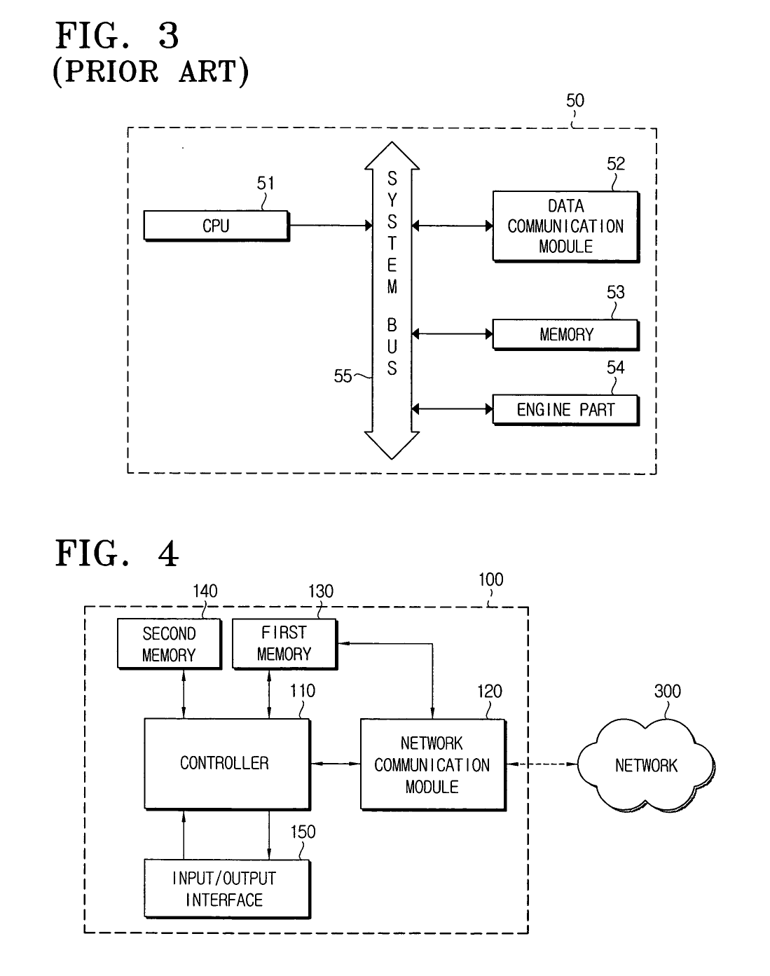

In the drawing figures, it should be understood that like reference numerals refer to like features and structures.

### DETAILED DESCRIPTION OF THE PREFERRED EMBODIMENTS

Hereinafter, the present invention will be described in detail with reference to the accompanying drawings.

FIG. 4 is a block diagram showing a network communication node 100 according to an embodiment of the present invention. Referring to FIG. 4, the network communication node 100 comprises a controller 110, a network communication module 120, a first memory 130, a second memory 140, and an input/output interface 150. The network communication node 100 is connected to a network 300.

The input/output interface 150 transmits input signals received from an input device such as a key button and a touch screen to the controller 110, or transmits information about a current state or a current mode of the controller 110 to an output device such as a Liquid Crystal Display (LCD) panel (not shown).

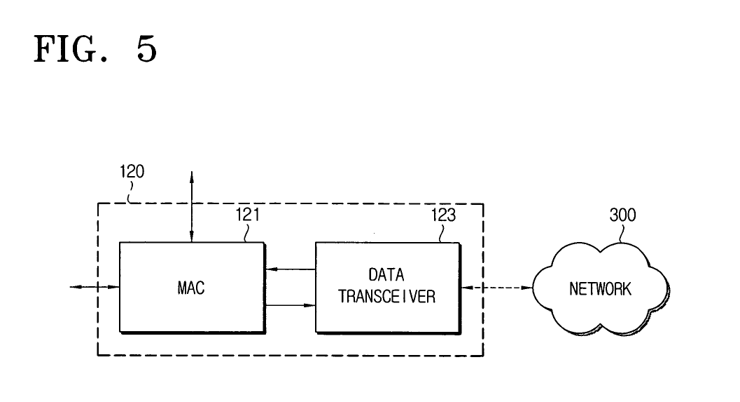

The network communication module 120 directly transmits and receives data to and from the network 300. The network communication module 120 is illustrated in FIG. 5 in detail.

Referring to FIG. 5, the network communication module 120 comprises a Media Access Controller (MAC) 121 and a data transceiver 123. The data transceiver 123 establishes a link with another device included in the network 300 to physically transmit and receive data to and from the device.

The MAC 121 controls overall data communications performed through the data transceiver 123. More specifically, the MAC 121 performs a Cyclic Redundancy Check (CRC) with respect to the data received by the data transceiver 123, determines whether the received packets are normal e.g., not having errors by comparing sizes of the packets, and if it is determined that the packets have errors, discards the received data packets. Also, the MAC 120 determines whether a destination address of the received packets is identical to the address of the network communication node 100, and if not, discards the packets. That is, the MAC 121 receives only the packets identified as being receivable among broadcast packets, multicast packets, and unicast packets having own address recorded as a destination address.

Referring to FIG. 4, the controller 110 designates a predetermined area of the first memory 130 to store the received packets, and processes the packets using a corresponding upper protocol layer or an application program. Also, the controller 110 checks a current packet receiving condition and determines whether to restrict the reception of the packets based on a predetermined criterion for reception restriction. The criterion for reception restriction is set based on a capacity of the first memory 130 storing the packets or a packet processing rate of the network communication node 100. For example, it is assumed that the capacity of the first memory 130 is used as the criterion for reception restriction. If the received packets occupy in the first memory 130 more than a predetermined reference capacity, the controller 110 restricts the reception of the packets, and if the received packets occupy in the first memory 130 not more than the predetermined reference capacity, the controller 110 allows the reception of the packets. In another example, a number of packets received per a time unit is used as the criterion for reception restriction. If the number of packets exceeds a predetermined threshold, the controller 110 restricts the reception of the packets

The second memory 140 stores information about the criterion for reception restriction used by the controller 110 or information about packets for reception restriction. That is, the information stored in the second memory 140 includes information about the packets to be restricted among the broadcast packets, the multicast packets, and the unitcast packets.

Meanwhile, which packets the MAC 121 receives or which packets to restrict is determined by inputting a command through the input/output interface 150 or according to an initial setting condition set in an initializing file of the network communication node 100.

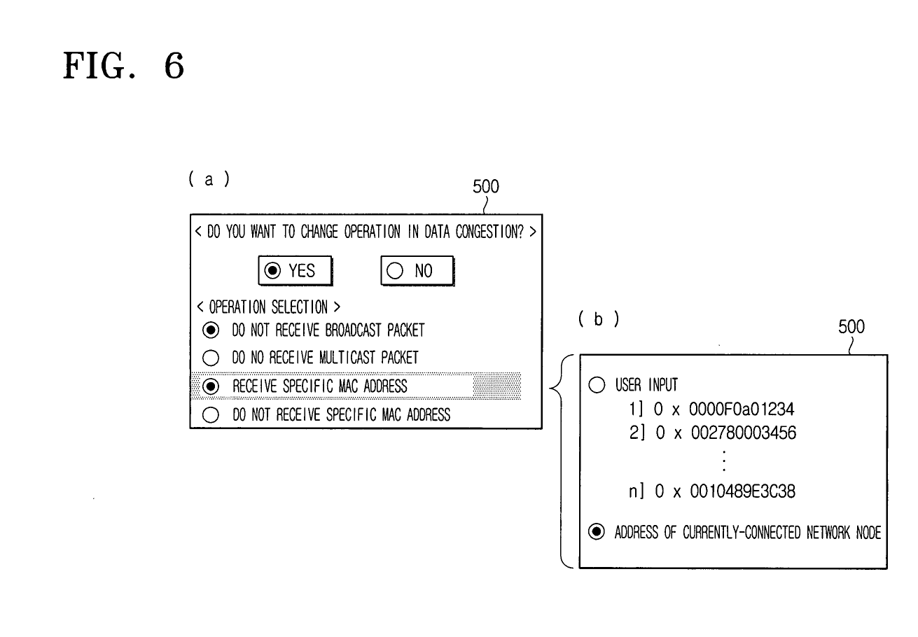

FIG. 6 is a view showing a user interface window 200 to determine whether to restrict the reception of packets and which packet to restrict.

As shown in (a) of FIG. 6, when a menu of “<Do you want to change operation in data congestion?>” is displayed on a user interface window 500, a user selects “YES” or “NO”. If the user selects “NO”, the data communication node 100 stores data packets as much as received without checking the occurrence of data congestion in the network like the conventional data communication node. However, if the user selects “YES”, the data communication node 100 detects the occurrence of data congestion in the network, and if the data congestion is detected, it restricts the reception of packets.

The packets to be restricted is also determined by the user. If “YES” is selected, <operation selection> is additionally displayed on the user interface window 500. As shown in (a) of FIG. 6, “Do not receive broadcast packet”, “Do not receive multicast packet”, “Receive specific MAC address”, and “Do not receive specific MAC address” are displayed. The user selects the packet he/she wants to restrict, so that the packets having a priority are firstly received in data congestion.

If the packets have a specific MAC address transmitted to the network communication node 100, the user separately determines the reception by selecting “Receive specific MAC address” or “Do not receive specific MAC address”. (b) of FIG. 6 shows a display view to separately set the MAC address. The user can restrict the reception of the unicast packets separately by way of directly inputting a specific address or selecting an address of the currently-connected network node. For example, if an ill-intentioned user continues to transmit data to the network system, the network system may be disconnected from existing communication nodes or an accessing rate to the network system becomes slow. At this time, the network system specifies the address of the ill-intentioned user and restricts the packet reception, thereby the network condition stabilizes. Meanwhile, even if there is no user's designating command to restrict the packet reception, the user can designate the packet to be restricted based on reception restriction information which has been set in an initializing file.

The network communication node 100 with the construction as shown in FIG. 4 can be applied to a network printer, a network multi-function peripheral, and a networked PC. As described above, when the data congestion is introduced in the network system having the network communication node 100 and a corresponding node connected to the network communication node 100, the reception of certain packets is restricted. In a network printing system comprising a network printer, if packets transmitted from several PCs are congested in the network printer, packet reception is restricted until the packets are processed to some degree and thus congestion is solved.

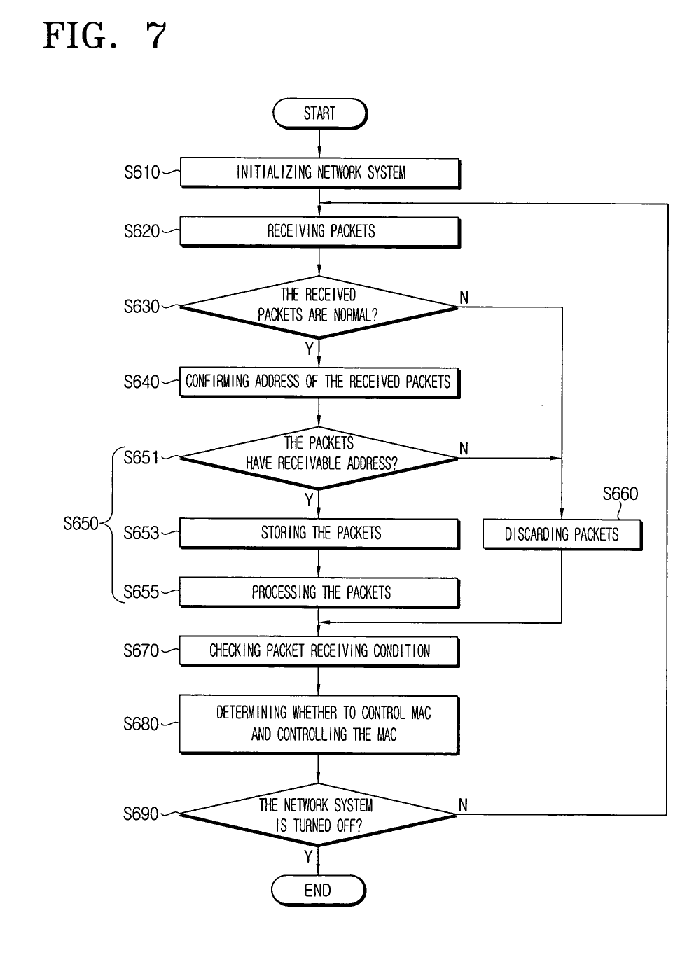

FIG. 7 is a flowchart showing exemplary steps of a data communication method performed by the network communication node 100 of FIG. 4. Referring to FIG. 7, when the network communication node 100 is turned on, an initializing is performed to set initialization values for the respective inner parts at step S610. If information about packets to be restricted has not been set, the information may be set in the initializing step based on the information stored in an initializing file.

Next, the data transceiver 123 of the network communication module 120 establishes a link with a corresponding node, and receives certain packets from the corresponding node at step S620. The MAC 121 detects the presence/absence of errors in the packets received by the data transceiver 123 at step S630, and confirms a destination address recorded on headers of the packets at step S640.

The MAC 121 selectively receives the packets based on the information about the packets for reception restriction stored in the second memory 140, and processes the received packets at step S650. More specifically, it is determined whether the packets have a receivable address at step S651, and if so, the packets are stored in the first memory 130 at step S653 and a predetermined interrupt signal is transmitted to the controller 110. The controller 110 processes the packets using a predetermined application at step S655. Meanwhile, if the packets have no receivable address and have errors, the packets are discarded without being stored in the first memory 130 at step S660.

Then, a packet receiving condition is checked at step S670. As a result of the check, it is determined whether to control the MAC 121, and the MAC 121 is controlled at step S680. The receiving activity of the packets and the checking of the packet receiving condition continue until the network communication node 100 is turned-off at step S690.

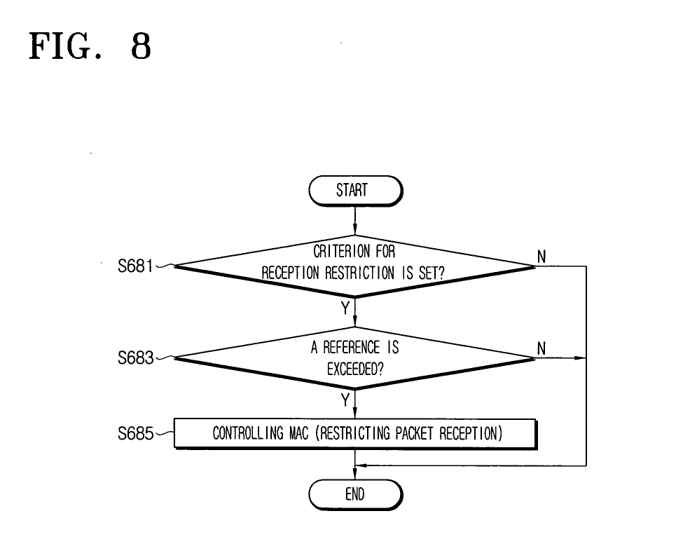

FIG. 8 is a flowchart showing exemplary steps of a method of controlling the MAC 121 according to a first embodiment of the present invention. Referring to FIG. 8, it is determined whether a criterion for reception restriction is set or not at step S681). The criterion for reception restriction may be set based on a capacity of the first memory 130 or a packet receiving rate of the network communication node 100. Also, the criterion for reception restriction may be set based on a number of packets received per a time unit. The criterion for reception restriction is pre-set by a developer of the network communication node 100 or a user, and recorded in the second memory 140, so that the controller 110 reads-out the criterion for reception restriction from the second memory 140.

If the capacity of the first memory 130 is used as the criterion for reception restriction, it is determined whether a storage capacity of packets, occupying in the first memory 130 and standing ready to be processed by an upper protocol layer or an application problem, is over a predetermined reference capacity. If so, the packets are restricted from being received.

Meanwhile, if the packet receiving rate is used as the criterion for reception restriction, the receiving rate is measured by checking an amount of data received for a predetermined period, and packets are restricted from being received when the measured receiving rate exceeds a reference receiving rate which is set in consideration of a capacity of the network system. For example, if the reference receiving rate of the network communication node 100 is set to approximately 100 KB/sec, the packets are restricted from being received when a receiving rate of 150 KB/sec is measured.

The controller 110 determines whether the criterion for reception restriction is satisfied at step S683, and if the criterion for reception restriction is satisfied, the MAC 121 is controlled to restrict the reception of packets at step S685. The packets for reception restriction may be selected through the user interface window 500 as shown in FIG. 6. Meanwhile, if the criterion for reception restriction is set based on the receiving rate, the packets are processed in the same manner as in FIG. 8.

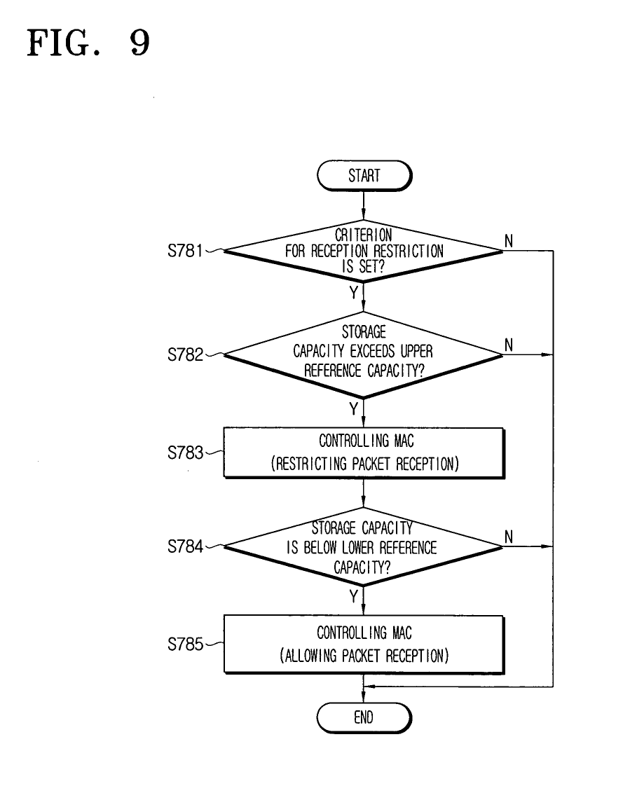

FIG. 9 is a flowchart showing exemplary steps of a method of controlling the MAC 121 according to a second embodiment of the present invention. According to this embodiment, a capacity of the first memory 130 is used as the criterion for reception restriction, and an upper reference capacity and a lower reference capacity are also set. If packets occupy more than the upper reference capacity in the first memory 130, the subsequent packets are restricted from being received. At this time, even if the preceding packets are processed and thus they occupy the first memory 130 less than the upper reference capacity, the reception restriction continues until the first memory 130 has a predetermined level of capacity. When the preceding packets are processed to some extent and they occupy the first memory 130 less than the lower reference capacity, the subsequent packets are allowed to be received. This is because if the packets are allowed to be received right after the preceding packets occupy the first memory 130 less than the upper reference capacity, even small amount of subsequent packets as received exceeds the upper reference capacity, and therefore, it is required to control the MAC 121 to restrict the reception of packets. As a result, the controller 110 suffers an overload. Accordingly, the reception restriction continues until a predetermined level of capacity is obtained, i.e., until the packets occupy less than the lower reference capacity.

According to the second embodiment, it is determined whether a criterion for reception restriction is set at step S781, and whether an upper reference capacity is exceeded at step S782. If the upper reference capacity is determined to be exceeded, the MAC 121 is controlled to restrict the reception of packets at step S783.

Next, it is determined whether a storage capacity of the packets in the first memory is below a lower reference capacity at step S784. If so, the MAC 121 is controlled to allow the reception of packets at step S785.

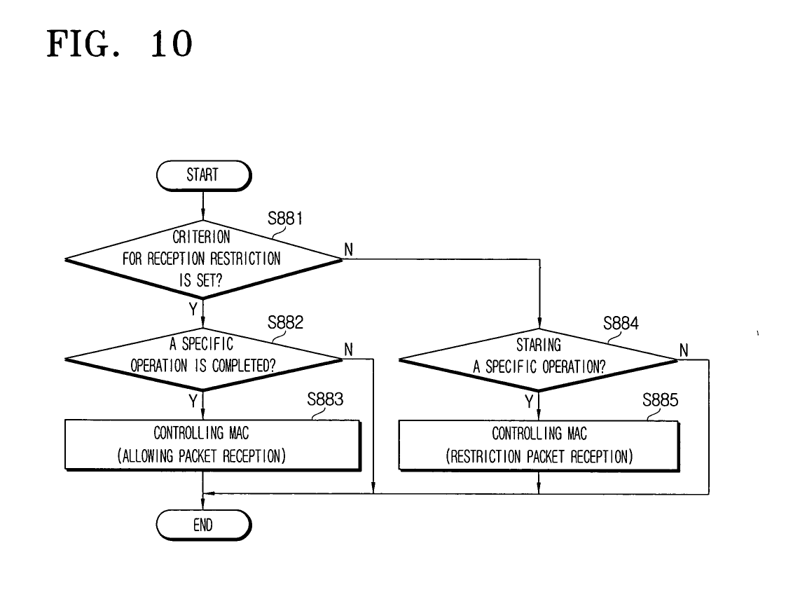

FIG. 10 is a flowchart showing exemplary steps of a method of controlling the MAC 121 according to a third embodiment of the present invention. According to the third embodiment, the restriction of packet reception is not determined depending on whether a criterion for reception restriction is satisfied, but determined depending on whether the controller 110 performs a predetermined calculation or not.

First, it is determined whether a restriction of reception of certain packets is set at step S881. If the reception restriction is set, it is determined whether the controller 110 completes a predetermined calculation at step S882. If so, the MAC 121 is controlled to allow the reception of packets at step S883.

Meanwhile, if it is determined that the controller 110 starts the predetermined calculation when no reception restriction is set at step S884, the MAC 121 is controlled to restrict the reception of the packets at step S885.

Unnecessary continuous data flow causes a calculation load to a node so that the node may not perform its main operation. The method according to the third embodiment prevents this problem. A network printer is used to explain the third embodiment. However, it should be appreciated by those skilled in the art that other network components can be substituted without departing from the scope of the present invention. On receipt of a print command from a user PC connected to the network printer through a network, the network printer performs a printing job. In this case, whether to restrict the reception of data is determined adaptively depending on whether the printing operation is being processed. That is, if data traffic congestion is detected during the printing operation, specific packets are restricted from being received by controlling the MAC 121 even in the case that no reception restriction is set. At this time, if the data congestion continues even in the restriction condition of the specific packets, the range of packets to be restricted is enlarged so that the main operation of the network printer i.e. printing operation is prevented from malfunctioning.

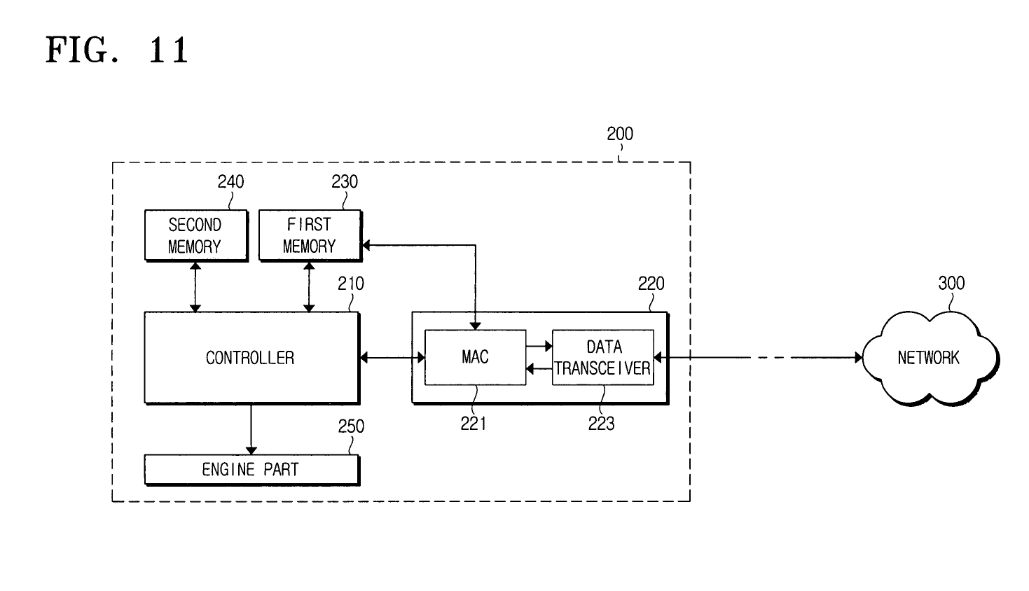

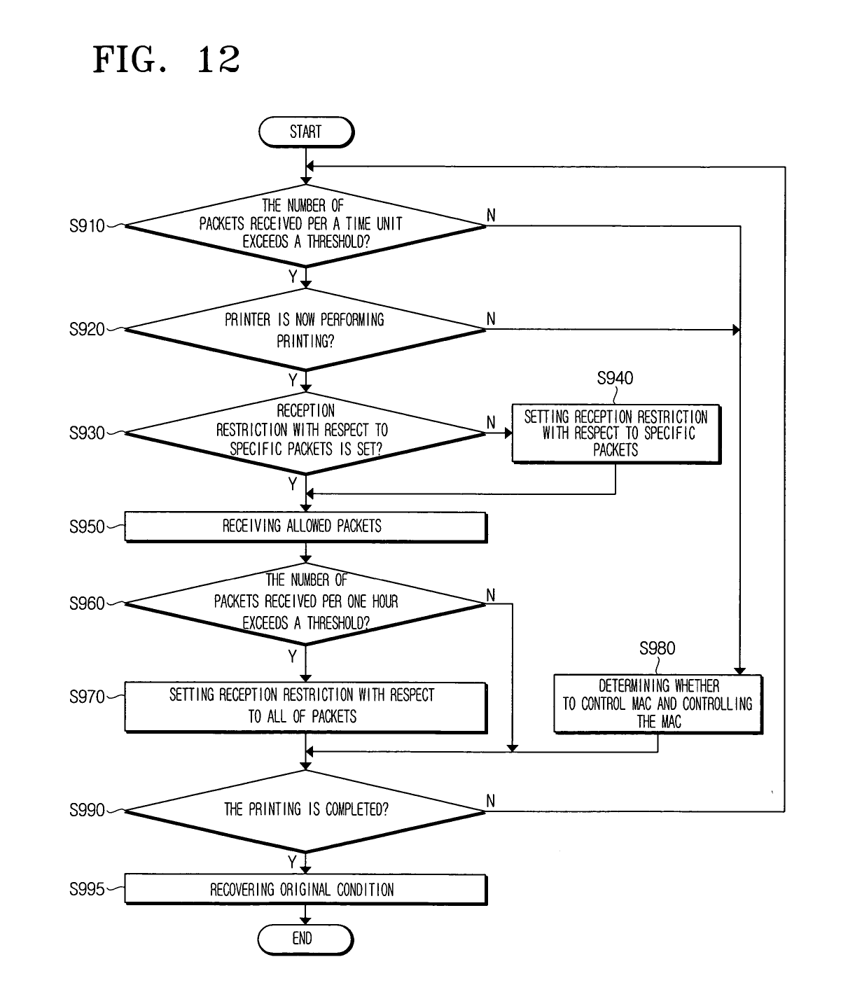

FIG. 11 is a block diagram showing a network printer 200 which restricts a packet receiving activity adaptively according to an embodiment of the present invention. Referring to FIG. 11, the network printer 200 comprises a controller 210, a network communication module 220, a first memory 230, a second memory 240, and an engine part 250.

The first memory 230 stores therein packets received from the network communication module 220, and the second memory 240 stores therein information about a criterion for reception restriction and information about whether a reception restricting function is set.

The network communication module 220 may comprise a MAC 221 and a data transceiver 223 similar to the embodiment in FIG. 5. Accordingly, the network communication module 220 receives certain packets from an external PC connected thereto through the network, stores the packets in the first memory 230, and transmits a predetermined interrupt signal to the controller 210 to notify it of that the packets are received.

The controller 210 checks the number of packets received through the network communication module 220, a storage capacity, or a transmitting rate to determine whether the packets are normally received or whether data congestion occurs. In this case, the determination is based on a criterion for reception restriction stored in the second memory 240. For example, the number of packets received through the network communication module 220 is counted, and if the counted number is less than a predetermined threshold stored in the second memory 240, it is determined that packets are normally received. If the counted number exceeds the threshold, it is determined that the packets are congested. The threshold is an optimal value that is experimentally obtained in consideration of a packet processing rate, a calculation ability of the controller 210, or a transmitting rate of a system bus connecting the controller 210 and respective components.

Meanwhile, on receipt of a print data written in a predetermined printing language through the network communication module 220, the controller 210 performs a rendering to convert the print data into a predetermined image data, and transmits the converted data to the engine part 250. The image data may be a bitmap image. The engine part 250 actually prints the data on a paper. In the case of a laser printer, the engine part 250 comprises a OPC drum, a developing unit, a charging unit, a Laser Scanning Unit (LSU), a transferring unit, and a fusing unit.

The controller 210 determines whether the network printer is presently performing the printing operation during data congestion. If the network printer is presently performing the printing operation, it is determined whether a reception restriction is set in the second memory 240. If the reception restriction is set, the controller 210 controls the MAC 221 to restrict certain packets from being received. For example, if the reception restriction is set with respect to broadcast packets and multicast packets, the MAC 221 controls such that the broadcast packets and multicast packets are discarded right after being received. If no reception restriction is set, the controller 210 controls the MAC 221 to restrict certain packets from being received.

Meanwhile, the controller 210 periodically checks the packet receiving condition, and enlarges the range of packet restriction if the data congestion continues even in case the reception restriction is set. That is, in addition to the broadcast packets and the multicast packets, the unicast packets are restricted from being received.

The rendering is performed by the controller 210 in every page of the print data. Therefore, after the rendering is completed on one page and corresponding print data is transmitted to the engine part 250 for printing, there is a time to receive packets prior to rendering of the next page. Accordingly, under the condition where the reception restriction is set with respect to all of the packets, after a rendering of one page is completed, the reception restriction is set such that only specific packets are restricted from being received. For this, the controller 210 determines which part of each page undergoes the rendering. If each page is divided into several bands, the controller 210 relaxes the reception restriction when the rendering is performed with respect to the last band.

When it is determined that the printing operation is completed on the last page or that the data congestion is resolved, the original condition is recovered. That is, if the original condition is that all of the packets are allowed to be received, the reception restriction is completely canceled, and if the original condition is that only the specific packets are restricted from being received, the reception restriction is relaxed. Therefore, a printing malfunction of the network printer 200 due to the packet congestion can be prevented

FIG. 12 is a flowchart showing exemplary steps of a data processing method of the network printer 200 of FIG. 11. Referring to FIG. 12, the controller 210 of the network printer 200 counts the number of packets received from the outside, and determines if the number of packets received per a time unit exceeds a predetermined threshold at step S910.

If the number of packets exceeds the threshold, it is determined whether the network printer 200 is now performing a printing at step S920. Meanwhile, if the number of packets is below the threshold or if the network printer 200 is not performing a printing, whether to receive the data is determined according to the methods as shown in FIGS. 7 to 9 at step S980.

If the network printer is now performing a printing, it is confirmed whether reception restriction is set in the second memory 240 with respect to specific packets at step S930. If the reception restriction is set, the information about the packets to be restricted is read from the second memory 240, and the packets for reception restriction are immediately discarded right after being received at step S950.

Meanwhile, if the reception restriction is not set, pre-set specific packets are automatically restricted from being received at step S940. Such packets are discarded right after being received at step S950.

During the printing, it is determined whether there occurs data congestion by checking the number of packets periodically at step S960. If the data congestion is not resolved even in case the reception restriction is, all packets are restricted from being received at step S970.

If it is determined that the printing is completed at step S990, the original reception restriction condition is recovered at step S995. That is, if any reception restriction has not been set, the reception restriction is canceled. If the reception restriction has been set with respect to only the specific packets, the reception of packets other than the specific packets are allowed. In this case, the reception is allowed during an interval from when the rendering is completed on each page to when the rendering is performed with respect to the next page.

According to the above embodiments of the present invention, two steps of controlling the reception restriction are performed. Accordingly, the network printer 200 performs the printing job and the receiving of the packets, without being interfered with the packet congestion.

The embodiments are applied to a network printer by way of an example. ARP request packets are often congested in the network due intrusion of virus. In this case, if a reference value is exceeded or if broadcast packets are determined to be restricted, the broadcast packets such as ARP request packets are discarded right after being received. Especially, when the data congestion is detected during a printing operation even under the reception restricting condition with respect to the broadcast packet, a reception restriction of all of packets is set, thereby preventing the printing operation from being interfered. When the printing is completed, the reception restriction is relaxed so that an original condition is recovered.

As described above, when the data congestion is detected as a result of checking the packet receiving condition of the network communication node and the network system comprising the same, certain packets are restricted from being received so that the data congestion is solved immediately. Especially, in case that data is abnormally congested in the network by the intrusion of virus or an ill-intentioned user, the network operation can be stably maintained.

Also, in the case of a network printer, since the reception of unnecessary packets is restricted during the printing operation, the malfunction of the printer can be prevented.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A network communication node comprising:
a network communication module for receiving a predetermined number of packets from a predetermined corresponding node linked thereto through a network;
a memory for storing first information about a predetermined criterion for reception restriction and second information about packets which are restricted from being received when the criterion for reception restriction is satisfied; and
a controller for checking a packet receiving condition of the network communication module and determining whether the criterion for reception restriction is satisfied, and according to a result of the determination, controlling the restriction of the reception of the predetermined packets of the network communication module.

2. The network communication node as claimed in claim 1, further comprising an input/output interface for receiving a designation command from an external input device to designate the packet for reception restriction when the criterion for reception restriction is satisfied, wherein the controller records on the memory information about the designated packets.

3. The network communication node as claimed in claim 2, wherein the network communication module comprises:
a data transceiver for establishing a link to the corresponding node and receiving the packets through the link; and
a Media Access Control (MAC) address, if the packet receiving activity is controlled to be restricted, reading the second information from the memory, and storing in the memory receivable packets among the packets received through the data transceiver.

4. The network communication node as claimed in claim 3, wherein the criterion for reception restriction is determined by a reference capacity of the memory, and the controller determines that the criterion for reception restriction is satisfied if the received packets occupy in the memory more than the reference capacity, and sets the reception restriction.

5. The network communication node as claimed in claim 3, wherein the criterion for reception restriction is determined by an upper reference capacity and a lower reference capacity of the memory, and the controller sets the reception restriction if the received packets occupy more than the upper reference capacity in the memory, and allows the reception if the packets stored in the memory are processed and thus occupy less the lower reference capacity in the memory.

6. The network communication node as claimed in claim 1, wherein the controller determines whether to restrict the reception with respect to at least one of a broadcast packet, a multicast packet and a unicast packet.

7. A network printer comprises:
a data transceiver for receiving packets from a corresponding node connected to the network printer through a network;
an engine part for performing a printing according to a predetermined image data;
a controller for setting a reception restriction with respect to certain packets when detecting a packet congestion at the data transceiver during the printing; and
a Media Access Control (MAC) address, if the reception restriction is set, controlling the data transceiver to restrict the reception of the certain packets.

8. The network printer as claimed in claim 7, wherein the controller counts a number of packets received through the data transceiver per a time unit and compares the counted number with a predetermined threshold, and if the number of the received packets exceeds the threshold, confirms the packet congestion.

9. The network printer as claimed in claim 8, further comprising:
a first memory for storing packets received from the corresponding node; and
a second memory for storing information about packets for reception restriction when the packet congestion occurs, and information about the threshold.

10. The network printer as claimed in claim 9, wherein the controller periodically checks a packet receiving condition, and sets a reception restriction with respect to all of the packets when the packet congestion is determined to continue under the reception restriction condition.

11. The network printer as claimed in claim 10, wherein the controller converts a print data written in a print language into an image data by performing a rendering in every page, transmits the image data to the engine part to perform the printing, and, if the rendering with respect to each page is completed, allows the reception of all of packets prior to performing a rendering of the next page.

12. A data communication method of a network communication node which performs communication with a predetermined corresponding node linked thereto through a network, the method comprising the steps of:
(a) receiving a predetermined number of packets from the corresponding node at the network communication node;
(b) checking a packet receiving condition and determining whether a criterion for reception restriction is satisfied;
(c) if the criterion for reception restriction is satisfied, setting a reception restriction with respect to a pre-set packet; and
(d) restricting reception of the packets which the reception restriction is set on.

13. The data communication method as claimed in claim 12, further comprising the steps of:
determining which packet to restrict when the criterion for reception restriction is satisfied; and
if it is not determined which packet to restrict, determining which packet to restrict according to an initial setting condition of the network communication node.

14. The data communication method as claimed in claim 13, wherein the step of (c) uses a predetermined reference capacity of a memory provided in the network communication node as the criterion for reception restriction, and if a storage capacity of the received packets exceeds the reference capacity in the memory, determines that the criterion for reception restriction is satisfied.

15. The data communication method as claimed in claim 13, wherein the step of (c) uses a predetermined upper reference capacity and a lower reference capacity of a memory provided in the network communication node as the criterion for reception restriction, and if a storage capacity of the received packets exceeds the upper reference capacity in the memory, determines that the criterion for reception restriction is satisfied, and if the packets are processed and thus a storage capacity tin the memory is below the lower reference capacity, the step of (c) determines that the criterion for reception restriction is not satisfied and allows the reception.

16. A data receiving method of a network printer which receives packets from a corresponding node linked thereto through a network, the method comprising the steps of:
(a) receiving a predetermined print data from the corresponding node;
(b) converting the print data to a predetermined image data and printing the image data onto paper;
(c) checking a receiving condition of the packets received from the corresponding node during the printing;
(d) setting a reception restriction with respect to certain packets when the receiving condition is determined to be a packet congestion; and
(e) restricting the reception of the certain packet when the reception restriction is set.

17. The data receiving method as claimed in claim 16, wherein the step of (d) comprises the steps of:
counting a number of packets received from the corresponding node per a time unit;
comparing the number of packets received per a time unit with a predetermined threshold; and
if the number of packets exceeds the threshold, determining that the packet receiving condition is in a packet congestion.

18. The data receiving method as claimed in claim 17, further comprising the steps of:
periodically checking the packet receiving condition; and
setting a reception restriction with respect to all of the packets if it is determined that the packet congestion continues under the reception restriction condition.

19. The data receiving method as claimed in claim 18, further comprising the steps of:
if a print data written in a print language is received from the corresponding node, performing a rendering of converting the print data to a predetermined image data in every page; and
if the rendering is completed with respect to each page, allowing the reception of all of the packets prior to performing a rendering with respect to the next page.
